(19) United States
(12) Patent Application Publication
(10) Pub. No.: US 2025/0300555 A1
(43) Pub. Date: Sep. 25, 2025

(54) SWITCHED STEP-DOWN CONVERTER AND METHOD

(71) Applicant: STMicroelectronics International N. V., Geneva (CH)

(72) Inventor: Alexandre Pons, Vizille (FR)

(21) Appl. No.: 19/057,210

(22) Filed: Feb. 19, 2025

(30) Foreign Application Priority Data
Mar. 19, 2024 (FR) 2402718

(51) Int. Cl. H02M 3/156; H02M 1/00

(52) U.S. Cl. CPC H02M 3/156; H02M 1/0009

(57) ABSTRACT

The present description concerns a switched step-down converter and method. A first terminal receives a regulated voltage and is coupled to a reference potential by a resistor element. A main loop regulates the regulated voltage based on a comparison of a first voltage on the first terminal with a first threshold. A circuit enables a current source delivering a first current on the first terminal when the first voltage is lower than a second threshold. A current loop regulates the first voltage to the value of a third threshold by drawing a second current from the first terminal if the first voltage is higher than the third threshold.

### CROSS-REFERENCE TO RELATED APPLICATIONS

This application claims the priority benefit of French Patent Application No. 2402718 filed on Mar. 19, 2024, entitled “Switched step-down converter,” which is hereby incorporated herein by reference to the maximum extent allowable by law.

### TECHNICAL FIELD

The present disclosure generally concerns electronic circuits and methods, and more particularly switched step-down converters (“buck switched-mode power supplies”) and methods.

### BACKGROUND

FIG. 1 illustrates an example of a device 1 comprising a switched step-down converter 2.

Converter 2 is configured to regulate a voltage Vout to a set value determined by a threshold Th1.

Converter 2 comprises a terminal 200 configured to receive regulated voltage Vout. Converter 2 comprises a resistor element R (delimited by dotted lines in FIG. 1) coupling terminal 200 to a terminal 202 of converter 2, terminal 2 being configured to receive a reference potential GND, for example the ground. For example, a terminal of element R is connected to terminal 200 and another terminal of element R is connected to terminal 202.

Converter 2 comprises a high-side switch HS. The HS switch is connected between a terminal 204 of converter 2 and an output terminal 206 of converter 2. Terminal 204 is configured to receive a power supply potential Vin, potential Vin being higher than potential GND and higher than the regulated voltage set value Vout.

The terminals 200 and 206 of converter 2 are configured to be coupled to each other. Preferably, as is the case in device 1, terminals 200 and 206 are coupled to each other by an inductance L. For example, a terminal of inductor L is connected to terminal 200, another terminal of inductor L being connected to terminal 206. Preferably, inductor L does not form part of converter 2.

The terminals 200 and 202 of converter 2 are configured to be coupled to each other by a capacitive element C. The regulated voltage Vout is available across element C. For example, a terminal of element C is connected to terminal 200, another terminal of element C being connected to terminal 202. Preferably, element C does not form part of converter 2. As an example, element C corresponds to a smoothing capacitor and/or to a capacitor of a load (not shown in FIG. 1) powered with voltage Vout.

In the example of FIG. 1, converter 2 further comprises a low-side switch LS. The LS switch is connected between terminals 206 and 202.

Converter 2 comprises a main control loop 208 (delimited by dotted lines in FIG. 1).

Loop 208 is configured to compare the voltage Vfb on terminal 200 with threshold Th1, and to control the HS and LS switches based on the result of this comparison to regulate voltage Vfb, and thus voltage Vout, to its set value. For example, the value of threshold Th1 is equal to the set value of voltage Vout.

As an example, control loop 208 controls the HS and LS switches in pulse width modulation (PWM) and/or in pulse frequency modulation (PFM) and/or in pulse skip modulation (PSM).

As an example, control loop 208 comprises an operational amplifier AMP1 configured to compare voltage Vfb with threshold Th1, and to deliver a signal sig1 resulting from this comparison.

For example, amplifier AMP1 has an input receiving a voltage Vfb1 determined by voltage Vfb, another input receiving a voltage Vth1 determined by threshold Th1, and an output delivering signal sig1. For example, resistor element R is a voltage dividing bridge comprising two resistors R1 and R2 connected to each other in series between terminals 200 and 202, and voltage Vfb1 is available at a node of connection of resistors R1 and R2 to each other. The values of resistors R1 and R2, and those of voltage Vth1, are then determined so that the comparison of voltage Vth1 with voltage Vfb1 amounts to comparing voltage Vfb with threshold Th1.

As an example, loop 208 comprises a circuit CTRL configured to receive signal sig1, and to control the HS and LS switches based on signal sig1.

More specifically, loop 208 is configured to control the switching of the HS and LS switches in such a way as to increase the value of voltage Vout when voltage Vfb is lower than threshold Th1. In other words, loop 208 is configured to increase the regulated voltage Vout when voltage Vfb is lower than Th1.

Thus, when voltage Vout falls below its set value and voltage Vfb becomes lower than threshold Th1, control loop 208 controls the HS and LS switches so that voltage Vout increases towards its set value. When voltage Vout increases and becomes higher than or equal to its set value again, this results in voltage Vfb becoming higher than or equal to threshold Th1 again. Preferably, once voltage Vfb is higher than or equal to threshold Th1, loop 208 no longer controls the HS and LS switches so as to increase voltage Vout.

The operation described hereabove is true as long as terminal 200 effectively receives voltage Vout, that is, as long as voltage Vfb is effectively equal to Vout.

Indeed, if terminal 200 becomes disconnected from voltage Vout, that is, terminal 200 no longer receives voltage Vout, for example, because a solder joint of a wire or of a conductive track at terminal 200 is destroyed or defective, resistor element R draws the potential of terminal 200 to the potential of terminal 202, whereby voltage Vfb is zero.

Voltage Vfb is then lower than threshold Th1 and loop 208 thus controls the HS and LS switches so as to increase voltage Vout. In the absence of a disconnection between voltage Vout and terminal 200, this would have resulted in an increase in voltage Vfb. However, although voltage Vout increases, voltage Vfb remains zero due to the disconnection between voltage Vout and terminal 200. Voltage Vout then effectively rises well above its set value, and may reach values likely to damage a load powered with voltage Vout, or even to damage converter 2 itself, which is not desirable.

Although this is not shown in FIG. 1, there exist converters similar to converter 2 further comprising a circuit configured to detect an undervoltage of voltage Vout relative to its set value. This circuit is configured to compare voltage Vfb with a threshold Th2 lower than threshold Th1. This circuit is further configured to activate an alarm signal when voltage Vfb remains below threshold Th2 for a time period longer than a debounce period. When terminal 200 is properly connected to voltage Vout, the activation of the alarm signal means that voltage Vout has fallen below a low value lower than its set value for a time period longer than the debounce period, that is, there is an undervoltage detected on voltage Vout.

In a disconnection between terminal 200 and voltage Vout, due to the fact that voltage Vfb is zero, this signal for detecting an undervoltage of voltage Vout is thus activated at the end of the debounce period. It could thus be devised to use this alarm signal to disable the main control loop so that, in case of a disconnection between terminal 200 and voltage Vout, voltage Vout does not rise up to values capable of damaging the converter or the load that it powers.

However, this would result in the disabling of the main control loop in case of an undervoltage of voltage Vout, even though terminal 200 is effectively connected to voltage Vout, which is not desirable.

Further, in case of a disconnection between terminal 200 and voltage Vout, voltage Vout would still have time, during the debounce period preceding the activation of the alarm signal, to reach values likely to damage the converter or the load that it powers, which is not desirable.

### SUMMARY

There exists a need to overcome all or part of the disadvantages of known switched step-down converters, for example of switched step-down down converters of the type described in relation with FIG. 1.

For example, there exists a need to overcome all or part of these disadvantages when they result from, or are linked to, a disconnection between the voltage regulated by the converter and a terminal of the converter configured to receive this regulated voltage, that is, when these disadvantages result from a disconnection between this terminal of the converter and a node external to the converter on which the voltage regulated by the converter is available.

An embodiment overcomes all or part of the disadvantages of known switched step-down converters.

An embodiment provides a switched step-down converter comprising:
a first terminal configured to receive a voltage regulated by the converter;
a resistor element coupling the first terminal and a second terminal configured to receive a reference potential;
a main control loop configured to:
compare a first voltage at the first terminal with a first threshold, and
regulate, based on this comparison, the regulated voltage at a set value determined by the first threshold by controlling a high-side switch of the converter or the high-side switch and a low-side switch of the converter,
a selectively enablable current source configured in the active state to deliver a first current to the first terminal; an enabling circuit configured to enable the current source during at least one first time period when the first voltage goes below a second threshold lower than the first threshold; and
a current control loop configured to:
compare the first voltage with a third threshold higher than the first threshold,
regulate the first voltage at the value of the third threshold by drawing a second current from the first terminal if the first voltage is higher than the third threshold, and
do nothing if the first voltage is lower than the third threshold.

According to an embodiment, a product of a value of the resistor element by a value of the first current is higher than the third threshold.

According to an embodiment, the main control loop is configured to increase the regulated voltage when the first voltage is lower than the first threshold.

According to an embodiment, the current source is connected between the first terminal and a terminal of the converter configured to receive a supply potential.

According to an embodiment, the current control loop is configured so that, when the first voltage is higher than the third threshold, the second current drawn from the first terminal has a value determined by the difference between the first voltage and the third threshold.

According to an embodiment, the current control loop comprises a transimpedance amplifier having a first input configured to receive a voltage determined by the first voltage, a second input configured to receive a voltage determined by the third threshold, and an output coupled, preferably connected, to the first terminal and configured to draw the second current from the first terminal when the first voltage is higher than the third threshold.

According to an embodiment, the transimpedance amplifier comprises:
a differential pair receiving the respective inputs of the transimpedance amplifier; and
a transistor coupling the output of the transimpedance amplifier to the second terminal, a gate of the transistor being controlled by the differential pair.

According to an embodiment, the current control loop comprises a detector circuit configured to detect that the second current is non-zero, and to deliver a signal indicating when the second current is non-zero, the detector circuit comprising:
a transistor connected between a node and the second terminal and having a gate connected to the gate of the transistor of the transimpedance amplifier, and
another transistor configured to deliver a current to the node, the signal indicating when the second current is non-zero being determined from a potential of the node.

According to an embodiment, the current control loop comprises a detector circuit configured to detect that the second current is non-zero, and to deliver a signal indicating when the second current is non-zero.

According to an embodiment, the enabling circuit comprises:
a comparator configured to compare the first voltage with the second threshold and to deliver a binary signal indicating the result of the comparison; and
a circuit receiving the binary signal and being configured to enable the current source during at least the first time period when the binary signal switches to a state indicating that the first voltage is lower than the second threshold.

According to an embodiment, a value of the first current is configured so that, when the first terminal receives the regulated voltage, a fluctuation in the regulated voltage during the first time period during which the first terminal receives the first current is neglectable, for example so that an increase in the regulated voltage caused by the first current has a slope lower than 10 μV per microsecond.

According to an embodiment, the first time period is higher than the response time of the current control loop.

According to an embodiment:
the converter comprises a third terminal;
the high-side switch is connected between a terminal configured to receive a supply potential and the third terminal; and
the converter is configured so that its first and third terminals are coupled to each other, preferably through an inductor, and so that a capacitive element is connected between its second and first terminals.

According to an embodiment, the main control loop is configured to control switching of the high-side switch or of the high-side and low-side switches so that the regulated voltage is increased when the first voltage is lower than the first threshold.

Another embodiment provides a device comprising a converter such as defined hereabove, an inductor connected between the first and third terminals of the converter, and a capacitive element connected between the first and second terminals of the converter.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1, previously described, shows a device comprising an example of a switched step-down converter;

FIG. 2 shows an example of embodiment of a switched step-down converter;

FIG. 3 shows an example of implementation of a circuit of the converter of FIG. 2 according to an embodiment;

FIG. 4 illustrates in timing diagrams an example of operation of a switched step-down converter comprising an undervoltage detection circuit such as previously described;

FIG. 5 illustrates in timing diagrams an example of operation of the converter of FIG. 2.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the various circuits that can be powered with a voltage regulated by a switched step-down converter have not been detailed, since these circuits can also be supplied with a voltage regulated by a switched step-down converter according to the described embodiments and variants.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

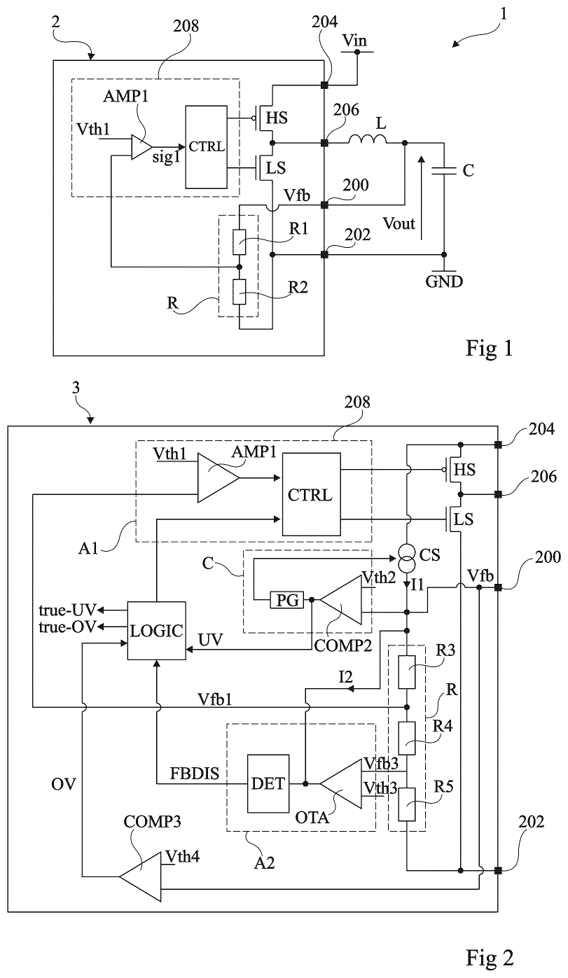

FIG. 2 shows an example of a switched step-down converter 3. Although this is not illustrated in FIG. 2, converter 3 may be used in the device 1 of FIG. 1, instead of converter 2.

Converter 3 comprises, like the converter 2 of FIG. 1, terminals 200, 202, 204, and 206, the HS switch, the LS switch, resistor element R, and main control loop 208.

However, as compared with converter 2, converter 3 further comprises a secondary control loop, or current control loop, A2, a selectively enablable current source CS, and an enabling circuit C.

Current source CS is configured, when it is controlled in the active state, to deliver a current I1 to terminal 200. As an example, current source CS is connected to terminal 200, for example between terminal 204 and terminal 200. Current I1 is a direct current (DC). When it is in the inactive state, current source CS delivers no current.

Thus, when terminal 200 is disconnected from voltage Vout and current source CS is enabled, current source CS is in series with resistor element R and current I1 flows through resistor element R.

Circuit C is configured to enable current source CS for at least a time period T1 when voltage Vfb becomes lower than a threshold Th2. Threshold Th2 is lower than threshold Th1.

For example, circuit CS is configured to compare voltage Vfb with threshold Th2, and to enable source CS for at least time period T1 when the result of this comparison indicates that voltage Vfb has just fallen below threshold Th2. No delay other than those due to signal propagation between the time when voltage Vfb has just fallen below threshold Th2 and the time when circuit C enables current source CS. Further, due to the fact that current source CS is enabled for at least time period T1 when voltage Vfb falls below threshold Th2, source remains CS enabled all along time period T1 even if voltage Vfb rises above threshold Th2 before the end of time period T1.

As an example, circuit CS comprises a comparator COMP2 configured to compare voltage Vfb with threshold Th2, and to deliver a signal sig2 indicating the result of this comparison. As an example, signal sig2 is a binary signal. As an example, comparator COMP2 has a first input receiving a voltage determined by voltage Vfb, a second input receiving a voltage Vth2 determined by threshold Th2, and an output delivering signal sig2. In the example illustrated in FIG. 2, the first input of circuit COMP2 directly receives voltage Vfb.

As an example, circuit CS comprises a circuit PG in addition to comparator COMP2. Circuit PG is configured to receive signal sig2, and to enable current source CS for at least time period T1 when this signal sig2 switches to a state indicating that voltage Vfb is lower than threshold Th2.

Current control loop A2 is configured to compare voltage Vfb with a threshold Th3. Threshold Th3 is higher than threshold Th1.

Control loop A2 is further configured, when voltage Vfb is higher than threshold Th3, to regulate voltage Vfb to the value of threshold Th3.

Thus, if voltage Vfb is higher than threshold Th3, it is also higher than threshold Th1, whereby main control loop 208 does not control the HS and LS switches to increase voltage Vout. As a result, when voltage Vfb is higher than threshold Th3, voltage Vout does not increase due to an action of main control loop 208.

More particularly, when voltage Vfb is higher than threshold Th3, control loop A2 is configured to regulate voltage Vfb to the value of threshold Th3 by drawing a current I2 from terminal 200. Preferably, the value of current I2 drawn from terminal 200 when voltage Vfb is higher than threshold Th3 is determined by, for example is proportional to, the difference between voltage Vfb and threshold Th3.

Further, when voltage Vfb is lower than threshold Th3, current control loop A2 is configured not to regulate voltage Vfb, that is, not to supply or draw any current to or from terminal 200. In other words, when voltage Vfb is lower than threshold Th3, loop A2 is configured to do nothing.

The operation of converter 3 when terminal 200 is suddenly disconnected from voltage Vout thus is the following.

First, voltage Vfb is drawn to potential GND by resistor element R, and thus falls below threshold Th2.

This causes the enabling of current source CS for at least a time period T1.

The enabling of current source CS results in that current I1 flows through the resistor element, and that voltage Vfb settles at a value higher than threshold Th3. The product of current I1 by the value of resistor element R is thus higher than threshold Th3. Preferably, the product of current I1 by resistor element R is lower than a maximum value of voltage Vfb, beyond which one or a plurality of circuits of converter 3 might be damaged.

Due to the fact that voltage Vfb is higher than threshold Th3, current control loop A2 starts drawing current I2 from terminal 200. As a result, the current flowing through resistor element R is equal to current I1 minus current I2, and voltage Vfb decreases to settle at the value of threshold Th3.

Since threshold Th3 is higher than threshold Th1, main control loop 208 does not increase the value of voltage Vout as long as the voltage Vfb remains regulated at the value of threshold Th3 by control loop A2. Thus, as long as value Vfb is regulated at threshold value Th3 by loop A2, voltage Vout does not increase to reach values that might damage converter 3 or the load that it powers.

Further, when terminal 200 is effectively connected to voltage Vout, the operation of converter 3 is the following.

If terminal 200 effectively receives voltage Vout, and voltage Vout is higher than threshold Th2, main control loop 208 regulates voltage Vout to its set value by comparing voltage Vfb, and thus Vout, with threshold Th1 and by controlling the HS and LS switches accordingly. Voltage Vfb is then lower than threshold Th3, and loop 2 draws no current from terminal 200. The operation of converter 3 is then identical to that of converter 2, circuits C, CS, and A2 here having no influence on this operation.

If terminal 200 effectively receives voltage Vout, and voltage Vout is lower than threshold Th2, for example because converter 3 is in a start-up phase, or because the load powered by converter 3 draws a current which causes voltage Vout to become lower than threshold Th2, circuit C enables current source CS for at least time period T1. Current I1 is then delivered to terminal 200, that is, to the load powered by the converter, capacitive element C, and resistor element R. The value of current I1 is configured so that, in this case, the variation in voltage Vout induced by the delivery of current I1 to terminal 200 during time period T1 is negligible. Thus, voltage Vout, and thus voltage Vfb, remain lower than threshold Th3, whereby loop A2 draws no current from terminal 200. Since loop A2 draws no current from terminal 200, and the enabling of current source CS has only a negligible influence on the value of voltage Vout, the operation of converter 3 is then identical to that of converter 2, circuits C, CS, and A2 here having no influence on this operation.

Preferably, time period T1 is selected to be longer than the response time of loop A2, or, in other words, is determined by the bandwidth of loop A2. This enables, in case of a disconnection between terminal 200 and voltage Vout, current source CS to still be delivering current I1 to terminal 200 when loop A2 begins to draw a non-zero current I2 from this terminal.

As an example, current I1 is configured so that an increase in the regulated voltage caused by the delivery of current I1 to terminal 200 has a slope lower than 10 μV per microsecond. For example, since capacitive element C has a generally high value, for example higher than 10 μF, current I1 is for example selected to be lower than 100 μA, whereby the slope of the increase in voltage Vout only resulting from the delivery of current I1 to terminal 200 is lower than 10 μV per microsecond.

As an example, circuit A2 comprises an operational transimpedance amplifier (OTA). The OTA amplifier has a first input configured to receive a voltage determined by voltage Vfb, a second input configured to receive a voltage determined by threshold Th3, and an output coupled, preferably connected, to terminal 200. The output of the OTA amplifier is configured to draw current I2 from terminal 200 when voltage Vfb is higher than threshold Th3.

For example, the OTA amplifier receives a voltage Vfb3 on its first input and a voltage Vth3 on its second input. For example, resistor element R is a voltage dividing bridge comprising three resistors R3, R4, and R5 series-connected between terminals 200 and 202 with resistor R5 connected to terminal 202, and voltage Vfb3 is available on a node of connection of resistors R5 and R4 to each other. In this example, voltage Vfb1 is available, for example, on the node of connection of resistor R4 to resistor R3. The values of resistors R3, R4, and R5 are then determined so that the comparison of voltage Vth1 with voltage Vfb1 amounts to comparing voltage Vfb with threshold Th1, and that the comparison of voltage Vfb3 with voltage Vth3 amounts to comparing voltage Vfb with threshold Th3. In this specific example, the values of resistors R3, R4, and R5 are preferably determined so that voltages Vth1 and Vth3 are equal, which enables to generate a single voltage instead of two, for example with a bandgap circuit.

An example of an implementation mode of a converter 3 enabling to protect a load powered with regulated voltage Vout from a disconnection between terminal 200 and voltage Vout has been described hereabove.

It may be desirable for converter 3 to indicate when such a disconnection occurs.

Thus, optionally, loop A2 is configured to deliver a signal FBDIS indicating when such a disconnection occurs. For example, loop A2 is configured to indicate when a non-zero current I2 is drawn from terminal 200. Indeed, when loop 200 draws a non-zero current I2 from terminal 200, this means that terminal 200 is disconnected from voltage Vout.

As an example, the current control loop comprises a detection circuit DET configured to detect that current I2 is non-zero, for example higher than a non-zero current value, and to deliver signal FBDIS indicating when current I2 is non-zero, or, in other words, indicating that terminal 200 is not connected to voltage Vout.

As an example, when loop A2 comprises the OTA amplifier as previously described, circuit DET is coupled to the output of the OTA amplifier.

As an example, when loop A2 is configured to deliver signal FBDIS, this signal may be delivered on an output terminal (not shown in FIG. 2) of converter 3, for example so as to indicate to the environment of converter 3 that terminal 200 is disconnected from the voltage.

As an alternative or complementary example, when loop A2 is configured to deliver signal FBDIS, main control loop 208 may be controlled by this signal FBDIS, for example to disable control loop 208 when a disconnection from terminal 200 is detected. In the example of FIG. 2, signal FBDIS is delivered to a circuit LOGIC, and circuit LOGIC controls loop 208 based on signal FBDIS. In other examples, not shown, signal FBDIS is directly delivered to loop 208 to control it.

Optionally, when loop A2 is configured to deliver signal FBDIS, converter 3 further comprises a circuit for detecting an undervoltage of voltage Vout. In the example of FIG. 2, in the absence of a disconnection between terminal 200 and voltage Vout, it is considered that voltage Vout exhibits an undervoltage if it is lower than a threshold Th5 lower than threshold Th1. The undervoltage detection circuit is then configured to detect when voltage Vfb is lower than threshold Th5 all along a debounce period and, if signal FBDIS indicates no disconnection between terminal 200 and voltage Vout, to indicate with an alarm signal true-UV that voltage Vout exhibits an undervoltage.

As an example, the undervoltage detection circuit comprises a comparator configured to compare voltage Vfb with threshold Th5, to deliver a signal UV, for example binary, indicating the result of this comparison. The undervoltage detection circuit further comprises a circuit configured to receive signal UV and signal FBDIS, and to deliver signal true-UV based on signals UV and FBDIS.

More particularly, in the example of FIG. 2, threshold Th5 is considered to be equal to threshold Th2. Thus, when circuit C comprises comparator COMP2, this comparator COMP2 may be shared between circuit C and the undervoltage detection circuit, signal UV then being available at the output of comparator COMP2. The undervoltage detection circuit further comprises circuit LOGIC configured to receive signals UV and FBDIS, and to deliver signal true-UV. As an example, this signal true-UV may be delivered on an output terminal (not shown in FIG. 2) of converter 3, for example to indicate to the environment of converter 3 that voltage Vout exhibits an undervoltage.

As an alternative example, when thresholds Th5 and Th2 are equal, signal true-UV can be determined based on signal UV only, for example by circuit LOGIC. In this case:
if terminal 200 is disconnected from voltage Vout, voltage Vfb is first lower than threshold Th2 equal to Th5 before being regulated to the value of threshold Th3, and will thus be higher than threshold Th2 at the end of the debounce period. Thus, at the end of the debounce period, signal UV will no longer indicate that voltage Vfb is lower than threshold Th2, and signal true-UV will not be activated; and
if terminal 200 is connected to voltage Vout, voltage Vfb will still be lower than threshold Th2 at the end of the debounce period if voltage Vout effectively exhibits an undervoltage. At the end of the debounce period, signal UV will thus indicate that voltage Vfb is lower than threshold Th2, and signal true-UV will be activated.

Optionally, converter 3 further comprises a circuit for detecting an overvoltage of voltage Vout. The overvoltage detection circuit is configured to detect when voltage Vfb is higher than a threshold Th4 all along a debounce period and, should this occur, to indicate with an alarm signal true-OV that voltage Vout exhibits an overvoltage. As an example, this signal true-OV may be delivered to an output terminal (not shown in FIG. 2) of converter 3, for example, to indicate to the environment of converter 3 that voltage Vout exhibits an overvoltage.

As an example, the overvoltage detection circuit comprises a comparator COMP3 configured to compare voltage Vfb with threshold Th4, to deliver a signal OV, for example binary, indicating the result of this comparison. The overvoltage detection circuit further comprises a circuit, for example circuit LOGIC in the example of FIG. 2, configured to receive signal OV, and to deliver signal true-OV based on signal OV. As an example, comparator COMP3 has a first input receiving a voltage determined by voltage Vfb, a second input receiving a voltage Vth4 determined by threshold Th4, and an output delivering signal OV. In the example illustrated in FIG. 2, the first input of circuit COMP3 directly receives voltage Vfb.

As an example, threshold Th4 is higher than threshold Th3. Thus, when terminal 200 is disconnected from the voltage, even if voltage Vfb rises above threshold Th4 when current source CS switches from an inactive state to an active state, voltage Vfb becomes lower again than threshold Th4 before the end of the debounce period due to the regulation of voltage Vfb to the value of threshold Th3 by loop A2.

As an alternative example, when threshold Th4 is lower than or equal to threshold Th3, when signal OV indicates all along the debounce period that voltage Vfb is higher than threshold Th4, the circuit delivering signal true-OV then determines this signal based on signal OV and on signal FBDIS. Indeed, at the end of this debounce period, signal true-OV will only indicate an undervoltage if signal FBDIS indicates no disconnection of terminal 200 from voltage Vout.

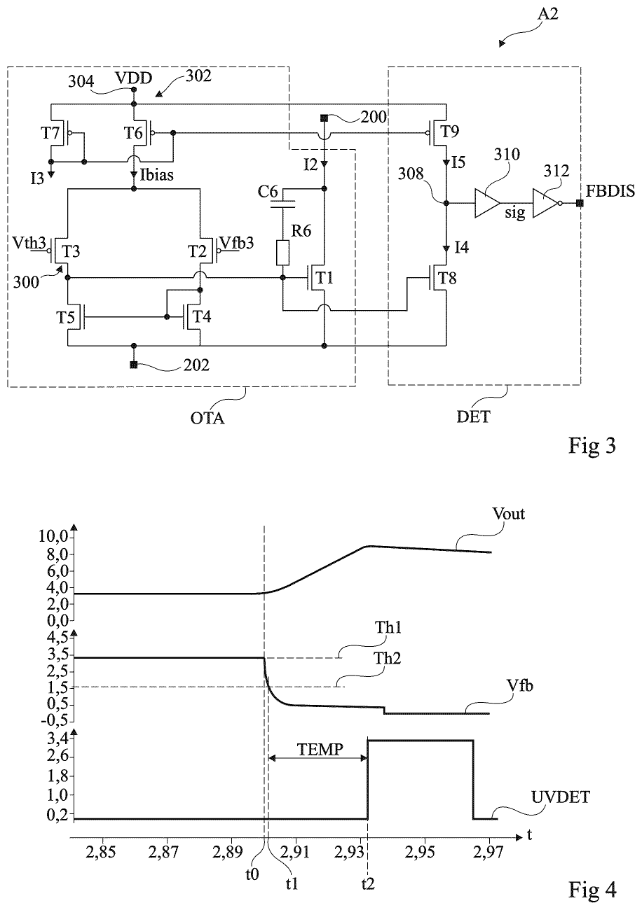

FIG. 3 shows an example of the circuit A2 of the converter of FIG. 2 according to an embodiment.

In the implementation of FIG. 3, circuit A2 comprises the OTA amplifier.

The OTA amplifier comprises a differential pair 300 receiving the respective inputs of the OTA amplifier, that is, voltages Vfb3 and Vth3 in this example. The OTA amplifier further comprises a transistor T1 coupling the output of the OTA amplifier to terminal 202, the output of the OTA amplifier being connected to terminal 200 and a gate of transistor T1 being controlled by the differential pair. More particularly, the transistor is controlled by differential pair 300 so that transistor T1 is non-conductive if voltage Vfb3 is lower than voltage Vth3 (voltage Vfb lower than threshold Th3) and is conductive if voltage Vfb3 is higher than voltage Vth3 (voltage Vfb higher than threshold Th3). When transistor T1 is conductive, current I2 is drawn from terminal 200 via the output of amplifier OTA. Preferably, the value of current I2 drawn from terminal 200, that is, the on-state resistance of transistor T1, when voltage Vfb3 is higher than voltage Vth3 depends on the difference between its two voltages.

As an example, transistor T1 is an NMOS transistor and has its source coupled, preferably connected, to terminal 202, and its drain coupled, preferably connected, to terminal 200.

As an example, differential pair 300 comprises two transistors T2 and T3, for example two PMOS transistors. Transistor T2 receives voltage Vfb3 on its gate and transistor T3 receives voltage Vth3 on its gate. The gate of transistor T1 is then connected to the first conduction terminal of transistor T3.

Transistors T2 and T3 have their first conduction terminals, for example their drains, coupled to terminal 202. For example, transistor T2, respectively T3, has its first conduction terminal coupled to terminal 202 by a transistor T4, respectively T5. Transistors T4 and T5 are, for example, NMOS transistors. Transistors T4 and T5 are assembled in a current mirror with each other. For example, transistor T4, respectively T5, has its source connected to terminal 202 and its drain connected to the first conduction terminal of transistor T2, respectively T3. Transistors T4 and T5 have their gates connected to each other and to the drain of transistor T4. Transistors T4 and T5 form, for example, an active load of differential pair 300.

Differential pair 300 is biased by a current source 302. Current source 302 is connected between the second conduction terminals, for example the sources, of transistors T2 and T3 and a node 304 connected to a supply potential VDD of the OTA amplifier. Preferably, potential VDD is lower than potential Vin (FIG. 2).

As an example, current source 302 comprises a transistor T6, for example PMOS, connected between node 304 and the second conduction terminals of transistors T2 and T3, and a transistor T7, for example PMOS. Transistor T7 is configured so that a current I3 flows therethrough, and transistors T6 and Ty are mirror-assembled to each other, so that a current Ibias determined by current I7 flows through transistor T6 and biases differential pair 300. For example, the source of each of transistors T6 and T7 is coupled, preferably connected, to node 304, the gates of transistors T6 and Ty are connected to each other and to the drain of transistor T7, and the source of transistor T6 is coupled, preferably connected, to the second conduction terminals of transistors T3 and T2.

Preferably, the gate of transistor T1 is coupled to terminal 200 by a series association of a resistor R6 and of a capacitor C6.

In the example of FIG. 2, the control loop comprises the optional circuit DET.

circuit DET comprises, in this example where the OTA circuit comprises differential pair 300 and transistor T1, a transistor T8 connected between a node 308 and terminal 202, the gate of transistor T8 being connected to the gate of transistor T1. Thus, the current I4 flowing through transistor T8 is determined by the current I2 in transistor T1, for example is equal to current I2. For example, transistor T8 is an NMOS transistor having its source connected to terminal 202 and its drain connected to node 308.

Circuit DET further comprises a transistor T9, for example PMOS, configured to deliver a current I5 to node 308. signal FBDIS is determined from the potential at node 308. For example, current I5 is determined so that the potential of node 308 is below a threshold Th6 when the current I4 determined by current I2, for example equal to current I2, is higher than current I5, and above this threshold Th6 when current I4 is zero or lower than current I5. In other words, in an example where current I4 is equal to current I2, circuit DET indicates that current I2 is non-zero when current I2 has a value higher than the value of current I5.

As an example, transistor T9 is assembled in a mirror with the transistors T6 and T7 of current source 302. For example, transistor T9 has its source connected to node 302, its drain connected to node 308, and its gate connected to the gates of transistors T6 and T7.

As an example, to determine signal FBDIS from the potential of node 308, circuit DET comprises a shaping circuit. For example, this shaping circuit comprises a comparator 310 configured to compare the potential of node 308 with threshold Th6, and to deliver a binary signal sig resulting from this comparison. Comparator 310 is, for example, a Schmitt trigger. Signal FBDIS is determined from signal sig. For example, signal sig is delivered to the input of an inverter 312, having its output delivering signal FBDIS. As an alternative example, signal FBDIS is signal sig.

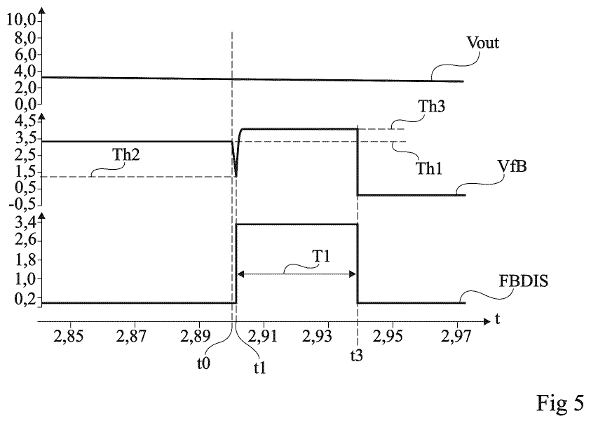

FIGS. 4 and 5 illustrate the difference in operation of converter 3 with respect to a

converter 2 in which a circuit UVDET for detecting an undervoltage of voltage Vout would be used to indicate a disconnection between terminal 200 and voltage Vout.

FIG. 4 illustrates with timing diagrams the operation of a converter 2 comprising a circuit for detecting an undervoltage of voltage Vout, this circuit being configured to deliver a signal UVDET in the high state at the end of a debounce period TEMP during which voltage Vfb has remained lower than a threshold Th2. FIG. 4 shows the variation, in volts, of voltage Vout, of voltage Vfb, and of signal UVDET as a function of time t in milliseconds.

Before a time t0, terminal 200 is connected to voltage Vout, and voltage Vout is regulated to its set value. In this example, the set value of voltage Vout is equal to 3.3 V. Voltage Vfb then is, in this example, equal to threshold Th1.

At a time t0, the connection between terminal 200 and voltage Vout is interrupted, and terminal 200 no longer receives voltage Vout.

From time t0, voltage Vfb decreases. In particular, at a time t1, voltage Vfb becomes lower than threshold Th2. In this example, threshold Th2 is equal to 1.2 V. As a result, a debounce period TEMP begins at time t1. In this example, the duration of period TEMP is equal to approximately 25 μs.

At a time t2 equal to t1+TEMP, since voltage Vfb has remained lower than threshold Th2 all along time period TEMP, signal UVDET is switched to the high state.

However, using this switching of signal UVDET to disable main control loop 208 is not sufficient. Indeed, during time period TEMP, due to the fact that voltage Vfb is lower than threshold Th1, loop 208 has controlled the HS and LS switches to increase voltage Vout. As a result, voltage Vout increases from time t0, and rapidly reaches, during time period TEMP, values likely to damage a load powered with voltage Vout. In the example of FIG. 4, voltage Vout increases to reach 9 V at the end of period TEMP.

FIG. 5 illustrates in timing diagrams the operation of converter 3. FIG. 5 shows the variation, in volts, of voltage Vout, of voltage Vfb, and of signal FBDIS as a function of time t in milliseconds.

Before time t0, the situation is the same as in FIG. 4.

At a time t0, the connection between terminal 200 and voltage Vout is interrupted, and terminal 200 no longer receives voltage Vout.

From time t0, voltage Vfb decreases. In particular, at time t1, voltage Vfb becomes lower than threshold Th2. In this example, as in FIG. 4, threshold Th2 is equal to 1.2 V. As a result, circuit C enables source CS for at least time period T1, and voltage Vfb rises back to a value higher than threshold Th1 and higher than threshold Th3.

Due to the fact that voltage Vfb is higher than threshold Th3, control loop A2 starts drawing a non-zero current I2 from terminal 200 and regulates voltage Vfb to the value of threshold Th3, as long as source CS is active. In this example, threshold Th3 is equal to 4 V. Circuit DET detects that current I2 is non-zero, and switches signal FBDIS to a state, here the high state, indicating that a disconnection of terminal 200 from voltage Vout has been detected.

Further, from time t1, due to the fact that voltage Vfb is higher than threshold Th1, loop 208 does not control the HS and LS switches to increase voltage Vout. On the contrary, from time t1, voltage Vout decreases with a slope determined by the power consumption of the load powered with voltage Vout and by the capacitance value of capacitive element C.

In this example, signal FBDIS is used to disable converter 3 when a disconnection between terminal 200 and voltage Vout is detected. Thus, at a time t3 subsequent to time t1, for example here equal to t1+T1, converter 3 is disabled, whereby voltage Vfb becomes zero and signal FBDIS switches to its low state.

As can be seen in FIG. 5, the overvoltage on voltage Vout resulting from a disconnection between terminal 200 and voltage Vout is less than 200 mV in this example, which enables not to damage the load powered with voltage Vout.

Various embodiments and variants have been described. Those skilled in the art will understand that certain features of these various embodiments and variants may be combined, and other variants will occur to those skilled in the art. For example, the implementation of circuits A2 and C is not limited to the above-described example of embodiments.

In particular, although a converter 3 comprising an HS switch and an LS switch and a control loop 208 controlling these two switches has been described above, in other examples not shown, the LS switch is replaced with a diode having its anode connected to terminal 202, loop 208 then being configured to only control the HS switch.

Further, although examples have been described in which voltages Vth1 and Vth3 are equal and where the respective voltages Vfb1 and Vfb3 are different, those skilled in the art will be capable of adapting these examples to cases where these two voltages Vth1 and Vth3 are different and the corresponding voltages Vth1 and Vth3 are different.

Finally, the practical implementation of the described embodiments and variants is within the abilities of those skilled in the art based on the functional indications given hereabove. In particular, those skilled in the art will be capable of determining the value of resistor element R, the value of current I1, duration T1, etc. to obtain the above-described operation.

What is claimed is:

1. A switched step-down converter comprising:
a first terminal configured to receive a voltage regulated by the converter;
a resistor element coupling the first terminal and a second terminal of the converter configured to receive a reference potential;
a main control loop configured to:
compare a first voltage at the first terminal with a first threshold; and
regulate, based on this comparison, the regulated voltage at a set value determined by the first threshold by controlling a high-side switch of the converter or the high-side switch and a low-side switch of the converter;
a selectively-enablable current source configured in active state to deliver a first current to the first terminal;
an enabling circuit configured to enable the selectively-enablable current source during at least one first time period when the first voltage goes below a second threshold lower than the first threshold; and
a current control loop configured to:
compare the first voltage with a third threshold higher than the first threshold;
regulate the first voltage at a value of the third threshold by drawing a second current from the first terminal in response to the first voltage being higher than the third threshold; and
do nothing, in response to the first voltage being lower than the third threshold.

2. The converter according to claim 1, wherein a product of a value of the resistor element and a value of the first current is higher than the third threshold.

3. The converter according to claim 1, wherein the main control loop is configured to increase the regulated voltage when the first voltage is lower than the first threshold.

4. The converter according to claim 1, wherein the selectively-enablable current source is connected between the first terminal and a terminal of the converter configured to receive a supply potential.

5. The converter according to claim 1, wherein the current control loop is configured so that, when the first voltage is higher than the third threshold, the second current drawn from the first terminal has a value determined by a difference between the first voltage and the third threshold.

6. The converter according to claim 1, wherein the current control loop comprises a transimpedance amplifier having a first input configured to receive a voltage determined by the first voltage, a second input configured to receive a voltage determined by the third threshold, and an output coupled to the first terminal and configured to draw the second current from the first terminal when the first voltage is higher than the third threshold.

7. The converter according to claim 6, wherein the transimpedance amplifier comprises:
a differential pair receiving the respective inputs of the transimpedance amplifier; and
a first transistor coupling the output of the transimpedance amplifier to the second terminal, a gate of the first transistor being controlled by the differential pair.

8. The converter according to claim 7, wherein the current control loop comprises a detector circuit configured to detect that the second current is non-zero, and to deliver a signal indicating when the second current is non-zero, the detector circuit comprising:
a second transistor connected between a node and the second terminal, and having a gate connected to the gate of the first transistor; and
a third transistor configured to deliver a current to the node, the signal indicating when the second current is non-zero being determined from a potential of the node.

9. The converter according to claim 1, wherein the current control loop comprises a detector circuit configured to detect that the second current is non-zero, and to deliver a signal indicating when the second current is non-zero.

10. The converter according to claim 1, wherein the enabling circuit comprises:
a comparator configured to compare the first voltage with the second threshold, and to deliver a binary signal indicating a result of the comparison; and
a circuit receiving the binary signal, and being configured to enable the selectively-enablable current source during at least the first time period when the binary signal switches to a state indicating that the first voltage is lower than the second threshold.

11. The converter according to claim 1, wherein a value of the first current is configured so that, when the first terminal receives the regulated voltage, a fluctuation in the regulated voltage during the first time period during which the first terminal receives the first current, is neglectable, so that an increase in the regulated voltage caused by the first current has a slope lower than 10 μV per microsecond.

12. The converter according to claim 1, wherein the first time period is higher than a response time of the current control loop.

13. The converter according to claim 1, wherein:
the converter comprises a third terminal;
the high-side switch is connected between a terminal of the converter configured to receive a supply potential and the third terminal; and
the converter is configured so that its first and third terminals are coupled to each other, and so that its first and second terminals are coupled to each other through a capacitive element.

14. The converter according to claim 13, wherein the main control loop is configured to control switching of the high-side switch or of the high-side and low-side switches so that the regulated voltage is increased when the first voltage is lower than the first threshold.

15. A device comprising:
a switched step-down converter comprising:
a first terminal configured to receive a voltage regulated by the converter;
a resistor element coupling the first terminal and a second terminal of the converter configured to receive a reference potential;
a main control loop configured to:
compare a first voltage at the first terminal with a first threshold; and
regulate, based on this comparison, the regulated voltage at a set value determined by the first threshold by controlling a high-side switch of the converter or the high-side switch and a low-side switch of the converter;
a third terminal, wherein the high-side switch is connected between a terminal of the converter configured to receive a supply potential and the third terminal;
a selectively-enablable current source configured in active state to deliver a first current to the first terminal;
an enabling circuit configured to enable the selectively-enablable current source during at least one first time period when the first voltage goes below a second threshold lower than the first threshold; and
a current control loop configured to:
compare the first voltage with a third threshold higher than the first threshold;
regulate the first voltage at a value of the third threshold by drawing a second current from the first terminal in response to the first voltage being higher than the third threshold; and
do nothing, in response to the first voltage being lower than the third threshold;
an inductor connected between the first and third terminals of the converter; and
a capacitive element connected between the first and second terminals of the converter.

16. A method of operating a switched step-down converter comprising first and second terminals coupled by a resistor element, the method comprising:
receiving, by the first terminal, a voltage regulated by the converter;
receiving, by the second terminal, a reference potential;
comparing, by a main control loop, a first voltage at the first terminal with a first threshold;
regulating, by the main control loop, based on this comparison, the regulated voltage at a set value determined by the first threshold by controlling a high-side switch of the converter or the high-side switch and a low-side switch of the converter;
delivering, by a selectively-enablable current source in active state, a first current to the first terminal;
enabling, by an enabling circuit, the selectively-enablable current source during at least one first time period in response to the first voltage going below a second threshold lower than the first threshold;
comparing, by a current control loop, the first voltage with a third threshold higher than the first threshold; and
regulating, by the current control loop, the first voltage at a value of the third threshold by drawing a second current from the first terminal in response to the first voltage being higher than the third threshold.

17. The method according to claim 16, wherein a product of a value of the resistor element and a value of the first current is higher than the third threshold.

18. The method according to claim 16, further comprising increasing, by the main control loop, the regulated voltage in response to the first voltage being lower than the first threshold.

19. The method according to claim 16, further comprising determining, by the current control loop, a value of the second current drawn from the first terminal by a difference between the first voltage and the third threshold, in response to the first voltage being higher than the third threshold.

20. The method according to claim 16, further comprising, by a detector circuit of the current control loop:
detecting that the second current is non-zero; and
delivering a signal indicating that the second current is non-zero.
